(19) United States
(12) Patent Application Publication
(10) Pub. No.: US 2007/0046589 A1
(43) Pub. Date: Mar. 1, 2007

(54) Current driver circuit for a current-driven type of image displayer

(75) Inventor: Shuji Furuichi, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/448,129

(22) Filed: Jun. 7, 2006

(30) Foreign Application Priority Data
Aug. 31, 2005 (JP) 2005-250540

(51) Int. Cl. G09G 3/30

(52) U.S. Cl. 345/76

(57) ABSTRACT

A current driver circuit includes a current output terminal, a data electrode terminal, an active current conductive element, and a modification circuit. The current output terminal supplies a drive current with a magnitude according to a data signal supplied thereto to a data electrode terminal of a current-driven type image displayer. The active current conductive element includes a current supply terminal receiving a drive voltage and being connected to the current supply terminal and having an impedance viewed from the current supply terminal, which is impedance is adjustable under the gate control based on data signal. The current driver circuit can display images of gradation greatly changing in magnitude with less distortion.

### BACKGROUND OF THE INVENTION

1. Field of the Invitation

The present invitation relates to a current driver circuit that drives a current-driven type image displayer such as an organic electroluminescence image displayer, which can adjust an output current so as to perform gradation correction. The present invention also relates to an image displayer using such current driver circuit.

2. Description of the Related Art

FIG. 1 of the accompanying drawings illustrates a schematic configuration of a current-driven type image displayer used in a conventional current driver circuit disclosed in Japanese Patent Kokai No. 2000-293245.

The current-driven type image displayer is an organic electroluminescence image displayer, and has an electroluminescence display panel 10 for displaying images. The electroluminescence display panel 10 has a plurality of row lines 11 and a plurality of column lines 12 which cross each other. Organic electroluminescence elements 13 are connected to the lines at the respective cross points of the row lines 11 and the column lines 12 and are arranged to form a matrix. A row line selection circuit 20 is connected to the row lines 11. A current driver circuit 30 is connected to the column lines 12. Based on control signals from control circuits (not shown), the row line selection circuit 20 that includes the switching elements 21 for selection of each of the row lines 11 selects desired row lines 11.

The current driver circuit 30 drives the column lines 12 to turn on the organic electroluminescence elements 13 by supplying constant current representing display data (e.g., gradation data) to the output terminals OUT1, OUT2, OUT3, . . . . The current driver circuit 30 includes control circuits (not shown), a reference voltage generation circuit 40, the driver cells 50-1, 50-2, 50-3, . . . , and so on. The reference current generation circuit 40 is connected between a power source terminal VDD and a ground terminal GND, and generates a reference display voltage Vdata according to display data. The reference current generation circuit 40 issues a reference current Iref between the power source terminal VDD and the ground terminal GND based on a reference voltage Vvel given from a reference voltage terminal VEL. The driver cells 50-1, 50-2, 50-3, . . . , are connected to the output of the reference current generation circuit 40. The driver cells 50-1, 50-2, 50-3, . . . , are circuits that respective supply constant current Iout1, Iout2, Iout3, . . . , which are proportional to a reference currents Iref, to the driver output terminals OUT1, OUT2, OUT3, . . . respectively. The driver output terminals OUT1, OUT2, OUT3, . . . , are connected to the column lines 12 respectively.

FIG. 2 of the accompanying drawings illustrates a schematic circuit configuration of the reference voltage generation circuit 40 shown in FIG. 1. The reference voltage generation circuit 40 has a load resister 41 and an N-channel type MOS transistor 43 (called ‘NMOS’ herein below) connected in series between the power source terminal VDD and the ground terminal GND. The gate of the NMOS 43 is controlled by a voltage follower operation of an operational amplifier 42. The operational amplifier 42 has a non-inverting terminal which is connected to a connection point of the load resister 41 and the NMOS 43, an inverting terminal which is connected to the reference voltage terminal VEL, and an output terminal which is connected to both the gate of the NMOS 43 and a display voltage terminal DATA.

The reference current Iref flowing between the power source terminal VDD and the display voltage terminal DATA is dependent on the reference voltage Vvel inputted from the reference voltage terminal VEL and the load resister 41. A terminal voltage across the load resister 41 Vr becomes equal to the reference voltage Vvel because of voltage follower operation of the operational amplifier 42. As a result, a magnitude value of the reference current Iref becomes a value resulted from the reference voltage Vvel/a resistance value r of load resister 41. The reference display voltage Vdata is supplied via the display voltage terminal DATA to the driver cells 50-1, 50-2, 50-3, . . . , 50-N.

FIG. 3 of the accompanying drawings illustrates a schematic circuit configuration of the driver cell 50-1 of FIG. 1. The driver cell 50-1 has a circuit configuration the same as other driver cells 50-2, 50-3, . . . , 50-N and includes an NMOS 51. The NMOS 51 has a gate which is connected to the display voltage terminal DATA, a drain which is connected to the output terminal OUT1, and a source which is connected to the ground terminal GND. When the NMOS 51 includes the same type of element as the NMOS 43 illustrated in FIG. 2, the output current Iout1 flowing through the output terminal OUT1 becomes equal to the reference current Iref.

When one of the column lines 12 is driven by an output current Ioutl, the output current Ioutl flows through a current path including the power source terminal VDD of the row line selection circuit 20, ‘on’ status of a switching element 21, a row line 11, an electroluminescence element 13, a column line 12 and an output terminal OUT.

As a result, the electroluminescence elements 13 light at a gradation (luminance) represented by a display data.

FIG. 4 of the accompanying drawings illustrates a schematic circuit configuration of a current-driven type image displayer including a conventional current driver circuit. Similar reference numerals and symbols are used in FIG. 1 and FIG. 4.

The current-driven type image displayer is an organic electroluminescence image displayer, including an organic electroluminescence panel 10 and a row line selection circuit 20 having the same arrangement as illustrated in FIG. 1, as well as a current driver circuit 60 which has a different arrangement from that illustrated in FIG. 1. The current driver circuit 60 includes a control circuit 61 that outputs control signals sw1, sw2, . . . , in predetermined timings, a reference current generation circuit 62 that outputs a reference voltage Vref by generating a reference current Iref, a digital/analog converter 70 (called ‘current DAC’ herein below) that converts digital display datas Din respectively representing display currents into analog displaying signals Snk, and a plurality of driver cells 80-1, 80-2, . . . , 80-N that respectively drive the column lines 12.

FIG. 5 of the accompanying drawings illustrates a schematic circuit configuration of the current DAC 70 depicted in FIG. 4. Based on the reference voltage Vref supplied from the reference current generation circuit 62, for example, this current DAC 70 produces the display signals of currents Snk (=Iref*Din) which is proportional to the display data Din of, for example, eight bits. The current DAC 70 includes an NMOS 71 to receive the reference voltage Vref, a p-channel type MOS transistor 72 (called ‘PMOS’ herein below) functioning as a load resister, a current converter part 73, etc. The NMOS 71 and the PMOS 72 are connected between a ground terminal GND and a power source terminal VDD in series with each other. The current converter part 73 includes a plurality of PMOSs constituting a current mirror circuit together with the PMOS 72.

FIG. 6 of the accompanying drawings illustrates a schematic circuit configuration of the driver cell 80-1 of FIG. 4. The driver cell 80-1 has the same circuit configuration as other driver cells 80-2, . . . , 80-N. The driver cell 80-1 latches a display signal current Snk supplied from the current DAC 70 and supplies an output current Iout1 via an output terminal OUT1 to drive the column line 12. This driver cell 80-1 includes switches 81, 83 for on/off switching operation in response to control signals sw1 and sw2, an NMOS 82 which is a load resister, a capacitor 84 which performs current/voltage conversion (called ‘I/V conversion’ herein below) in order to control a gate voltage Vgn, and an NMOS 85 which supplies output current Iout1 according to a gate terminal voltage Vgn to the output terminal OUT1.

FIG. 7 of the accompanying drawings illustrates timing charts representing signals appearing in circuits of FIG. 4 and FIG. 6. In the driver cell 80-1, the switches 81, 83 become ON during a current writing time T1, and a display signal current Snk which is proportional to a data D1 within a display data (D1, D2, . . . , DN) flows through the NMOS 82 and the capacitor 84. A gate terminal voltage Vgn proportional to this display signal current Snk is generated. This writing time T1 is dependent on the display signal current Snk, the gate terminal voltage Vgn and a magnitude of the capacity value Cap of the capacitor 84. The writing time T1 is represented by:
T1=(Cap*Vgn)/Snk.

During a next holding time T2, the switches 81, 83 become OFF, and an output current lout1 flows across the source and the drain of the NMOS 85 by the gate terminal voltage Vgn held in the capacitor 84. As a result, after the column line 12 is driven through the output terminal OUT1, an organic electroluminescence element 13 lights.

In other driver cells 80-2, . . . , 80-N, writing and holding of the display signal current Snk proportional to the display data D2, . . . , DN are performed in similar manner. The organic electroluminescence elements 13 light in response to output current Iout2, . . . , Ioutn flowing through output terminals OUT2, . . . , OUTN in order.

However, the conventional current driver circuits 30 and 60 illustrated in FIG. 1 and FIG. 4 respectively, encounter two problems (1) and (2) as mentioned below:

Problem (1):

In the current driver circuit 30 illustrated in FIG. 1, a variable range of the reference display voltage Vdata is dependent on an operation range of the operational amplifier 42 in the reference voltage generation circuit 40. When the display voltage Vdata is near the ground potential VSS (=0 V), or when black color or low gradation black color should be dispalyed, an error in the display voltage Vdata increases against the reference voltage Vvel because of an offset voltage of the operational amplifier 42. The output terminal OUT1 for the current output Iout1 supplies a current in response to a current drawing function (the reference current Iref>0) at the driver cell 50-1 illustrated in FIG. 3. As a result, a sub-threshold current flows through the NMOS 51 (which is a leak current across the source and the drain of the NMOS 51). Thus, it becomes difficult to adjust an amount of the reference current Iref (>>0) at a low gradation.

Problem (2):

In the driver cell 80-1 illustrated in FIG. 6 contained in the current driver circuit 60 illustrated in FIG. 4, a current writing time T1 (=(Cap*Vgn)/Snk) to write the display signal current Snk into a capacitor 84 is dependent on a display signal current Snk, a gate voltage Vgn and a magnitude of the capacity value Cap of the capacitor 84. Since a capacity size of the capacitor 84 is constant, an operational speed of the driver cell 80-1 is dependent on a magnitude of the display signal current Snk for writing. As a result, there is a problem that operational speed of the driver cell 80-1 becomes slow at writing of low gradation (when the display signal current Snk is slight). If the writing time T1 is made shorter in order to solve this problem, the gate voltage Vgn becomes lower, and an error in a magnitude of the output current Iout1 increases at low gradation.

### SUMMARY OF THE INVENTION

One object of the present invention is to provide a current driver circuit that drives a current-driven type image displayer while providing an accurate gradation display at even case of low gradation images.

According to a first aspect of the present invention, there is provided a current driver circuit that includes a current output terminal for supplying a drive current with a magnitude according to a data signal supplied thereto to a data electrode terminals of a current-driven type image displayer. An active current conductive element has a current supply terminal receiving a drive voltage and being connected to the current supply terminals and has impedance viewed from the current supply terminal and variable in response to a gate control based on a data signal. A modification circuit modifies impedance of the active current conductive element-in response to an external off-set control input signal supplied thereto.

The modification circuit may include a current mirror circuit having a first current passage connected to a current supply terminal of the active current conductive element and a second current passage causing a current of the same magnitude as a current passing through the first current passage to pass therethrough. The modification circuit may also have an off-set current control element inserted into the second current passage and having an impedance variable with an off-set control input signal.

The current driver circuit may have an adjusting circuit for adjusting a magnitude of the data signal in response to the off-set control input signal. As a result, a leak current of the active current conductive element, which causes a display voltage error around 0, is corrected.

The modification circuit may include the first D-A converter that converts an analog signal to data signal. The analog signal holding circuit may hold the analog signal to input the analog signal to the variable impedance element as a control input signal. The second D-A converter may convert an off-set control input signal to an analog control signal. The current source circuit may supply gate control current in response to the analog control signal to the active current conductive element. Operational speed of the current driver circuit can be improved with reducing current writing time to the current holding circuit by introducing the off-set control input signal.

### BRIEF DESCRIPTION OF THE DRAWINGS

FIG. 1 illustrates a schematic circuit configuration of a current-driven type image displayer that includes a conventional current driver circuit;

FIG. 2 illustrates a schematic circuit configuration of a reference voltage generation circuit shown in FIG. 1;

FIG. 3 illustrates a schematic circuit configuration of a driver cell illustrated in FIG. 1;

FIG. 4 illustrates a schematic circuit configuration of a current-driven type image displayer that includes another conventional current driver circuit;

FIG. 5 illustrates a schematic circuit configuration of a current DAC shown in FIG. 4;

FIG. 6 illustrates a schematic circuit configuration of a driver cell of FIG. 4;

FIG. 7 illustrates timing charts representing signals appearing in circuit of FIG. 4 and FIG. 6.

FIG. 8 illustrates a schematic circuit configuration of a current-driven image displayer that includes a current driver circuit according to a first embodiment of the present invention;

FIG. 9 illustrates a characteristic of either one of the NMOS, the NMOS and the PMOS in order to explain an operation of the current-driven type image displayer illustrated in FIG. 8;

FIG. 10 illustrates a schematic circuit configuration of a current drive circuit according to a second embodiment of the present invention;

FIG. 11 illustrates a schematic circuit configuration of a current-driven type image displayer that includes a current driver circuit according to a third embodiment of the present invention;

FIG. 12 illustrates a schematic circuit configuration, of a reference current generation circuit illustrated in FIG. 11;

FIG. 13 illustrates a schematic circuit configuration of a current DAC illustrated in FIG. 11;

FIG. 14 illustrates a schematic circuit configuration of a driver cell illustrated in FIG. 11; and

FIG. 15 illustrates timing charts representing signals appearing in the circuits of FIG. 11 and FIG. 14;

### DETAILED DESCRIPTION OF THE INVENTION

### First Embodiment

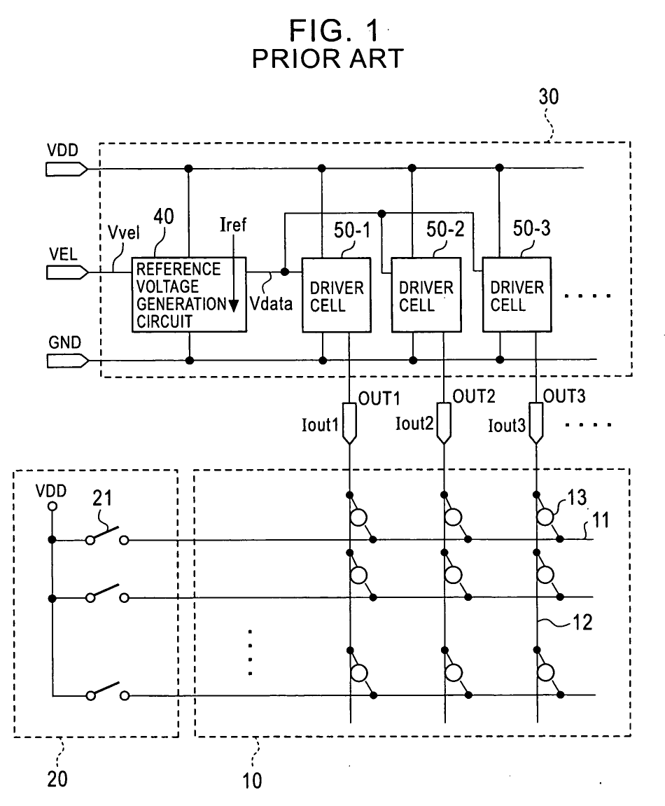

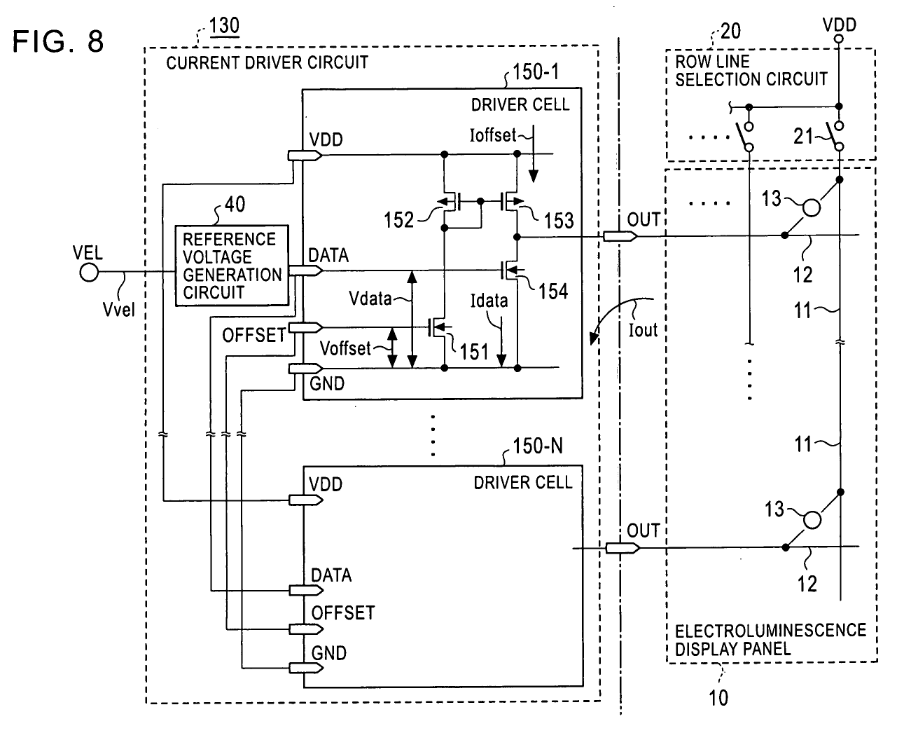

Referring to FIG. 8, a current-driven type image displayer (e.g., an organic electroluminescence image displayer) having a current driver circuit according to a first embodiment of the present invention will be described. Similar reference numerals and symbols as in FIG. 1 are used in FIG. 8.

The organic electroluminescence image displayer of the present embodiment includes an electroluminescence display panel 10 which displays images, a row line selection circuit 20 which is connected to the electroluminescence display panel 10, and a current driver circuit 130 (which is different from a conventional circuit) to drive a plurality of column lines 12 of the electroluminescence display panel 10.

The current driver circuit 130 drives the column lines 12 to consecutively light a plurality of electroluminescence elements 13 in response to a constant current representing a display data (e.g., a gradation data). The current driver circuit 130 includes control circuits (not shown) that generate various kinds of control signals, a reference voltage generation circuit 40 and a plurality of driver calls 150 (only one driver cell 150 is shown in FIG. 8).

The reference voltage generation circuit 40 is connected to a potential between a second power source potential node (e.g., a power source terminal VDD) and a first power source potential node (e.g., a ground terminal GND). The reference voltage generation circuit 40 causes a reference current Iref to flow across the power source terminal VDD and the ground terminal GND based on a reference voltage Vvel supplied from a reference voltage terminal VEL, and also generates an input signal (e.g., a reference display voltage Vdata representing the display data) to output Vdata from a display voltage terminal DATA. The driver cells 150 are connected to the output of the reference voltage generation circuit 40.

Each of the driver cells 150 includes a power source terminal VDD, a ground terminal GND, a display voltage. terminal DATA which receives the display voltage Vdata, a correction voltage terminal OFFSET which receives a correction signal (e.g., a correction voltage Voffset), and an output terminal OUT connected to the column line 12. Each of the driver cells 150 further includes second, third and fourth transistors (e.g., an NMOS151, a PMOS152, a PMOS153) each for injecting an injecting current, and a first transistor (e.g., an NMOS154) for providing a drawing current.

The correction voltage terminal OFFSET is connected to a gate of the NMOS 151 a source of which is connected to the ground terminal GND. A first node of a drain of the NMOS 151 is connected to both gates of the PMOS 152 and the PMOS 153 and also connected to a drain of the PMOS 152. The PMOS 152 and the PMOS 153 constitute a current mirror circuit. Both sources of the PMOS 152 and the PMOS 153 are connected to the power source terminal VDD. A drain of the PMOS 153 is connected to both of the output terminal OUT and a drain of the NMON 154. A source of the NMOS 154 is connected to the ground terminal GND.

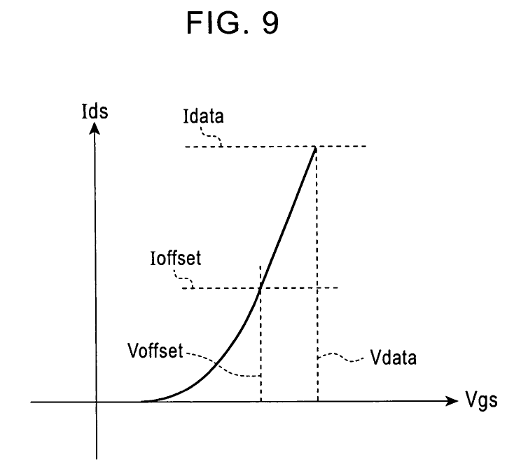

FIG. 9 illustrates characteristics of the NMOS 151, the NMOS 154 and the PMOS 153 in order to explain an operation of the current-driven type image displayer illustrated in FIG. 8

An abscissa of FIG. 9 represents a magnitude of a voltage Vgs across the gate and source terminals of the NMOS 151 and also the gate terminals and source of the NMOS 15. An ordinate of FIG. 9 represents a magnitude of a current Ids across the drain and source of the NMOS 151 and also the drain and source of the NMOS 154 respectively. The Voffset is a correction voltage which is applied across the gate and source of the NMOS 151. The Vdata is a display voltage which is applied across the gate and source of the NMOS 154. An Idata is a display current that flows through the drain and source of the NMOS 154. An Ioffset is a correction current that flows through the source and drain of the PMOS 153.

When a power source voltage is applied to the power source terminal VDD, the reference voltage Vvel is supplied to the reference voltage terminal VEL, and the reference voltage generation circuit 40 generates a reference display voltage Vdata representing a display data. This display voltage Vdata is supplied to the gate of the NMOS 154 via the display voltage terminal DATA. As a result, the display current Idata is generated across the drain and the source of the NMOS 154. When the correction voltage Voffset appears at the correction voltage terminal OFFSET, a first correction current is generated across the drain and source of the NMOS 151. The first correction current causes a second correction current which is proportional to the first correction current to flow into the output terminal OUT because of an operation of the current mirror circuit that has the PMOS 152 and the PMOS 153.

Output currents Iout viewed from the output terminal OUT are represented by an amount of Idata−Ioffset. By adjusting the correction voltage Voffset, not only a drawn current (=the display current Idata) by the NMOS 154, but also an injection current (=a correction current Ioffset) by the PMOS 153 are adjusted. When a gradation of a displayed image is low, errors in magnitude of the output currents Iout around 0 at the output terminals OUT are corrected respectively.

When the column lines 12 are driven by the output currents Iout respectively, the output currents Iout flow through current paths including: the power source terminal VDD of the row line selection circuit 20; ‘on’ status of the respective switching elements 21; the respective row lines 11; the respective electroluminescence elements 13; the respective column lines 12; and the respective output terminals OUT.

As a result, the respective electroluminescence elements 13 light at gradation (luminance) represented by the display data.

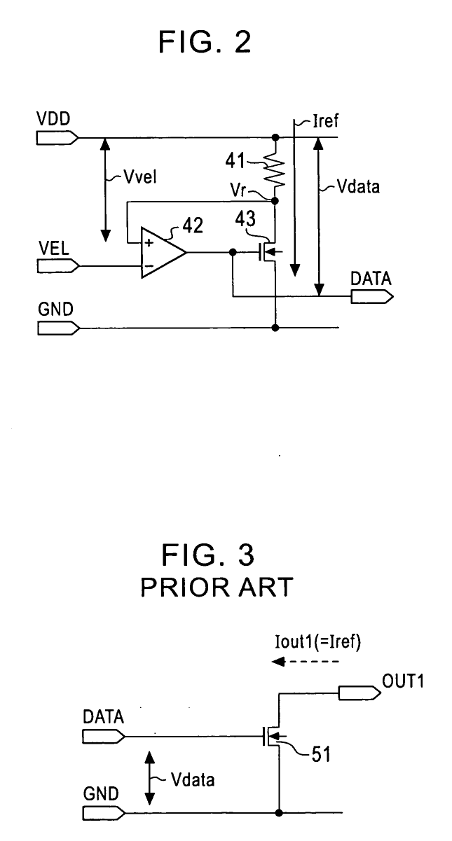

Since the driver circuit of the first embodiment includes a current push-pull configuration causing the display current Idata to be drawn by the NMOS 154 and the correction current Ioffset to be injected by the PMOS 153 at the output terminals OUT, the display voltage Vdata which is supplied to the gate of the NMOS 154 is shifted (moved) to a magnitude of a desired value by setting a magnitude of the correction voltage Voffset. For example, an output voltage of the operational amplifier 42 of the reference voltage generation circuit 40 illustrated in FIG. 2 is shifted within a range of operational output by shifting a magnitude of the the display voltage Vdata. As a result, a leak current of the NMOS 154, which causes a error in a display voltage around 0, is corrected.

### Second Embodiment

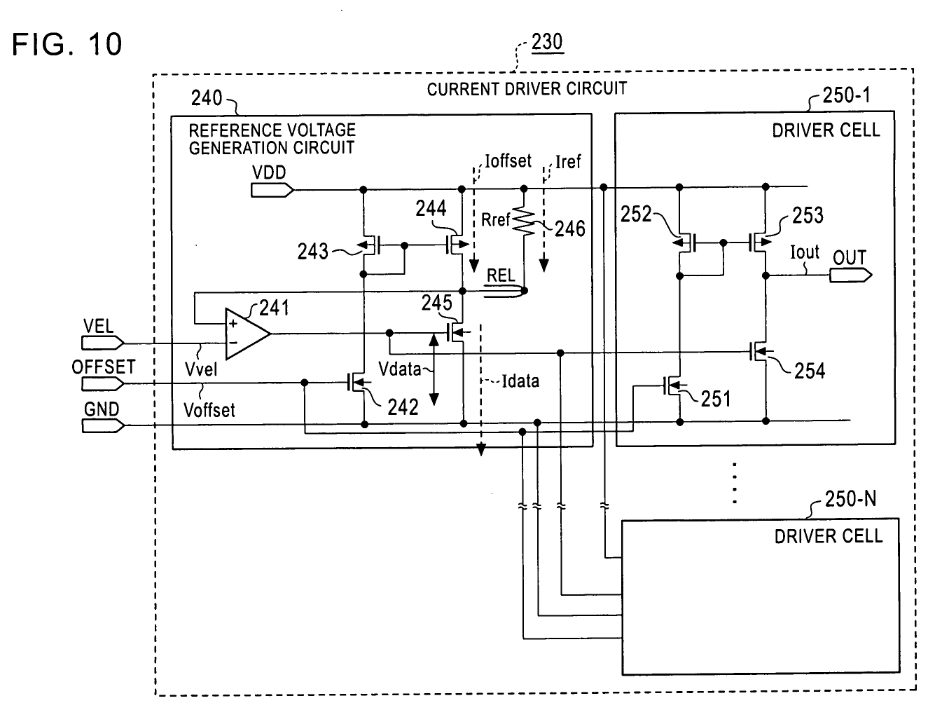

FIG. 10 illustrates a schematic circuit configuration of a current driver circuit according to a second embodiment of the present invention.

A current driver circuit 230 of the second embodiment drives an electroluminescence display panel 10 illustrated in FIG. 8 of the first embodiment, and includes control circuits (not shown) that generate various kinds of control signals, a reference voltage generation circuit 240, and a plurality of driver cells 250.

The reference current generation circuit 240 is comparable to a reference current generation circuit 40 illustrated in FIG. 2. The reference current generation circuit 240 includes a second power source node (e.g. a power source terminal VDD), a first power source node (e.g. a ground terminal GND), a reference voltage terminal VEL which receives input signals (e.g., a reference voltage Vvel), a correction voltage terminal OFFSET which receives correction signals (e.g., a correction voltage Voffset) and an output node (e.g., a reference current terminal REL) which flows a current Iref through itself. The reference current generation circuit 240 further includes a second, a third and a fourth transistor (e.g., an NMOS242, a PMOS243 and a PMOS244) as an injecting current generation element, a first transistor (e.g., a NMOS245) as a drawing current generation element and a resister 246 as a current setting element.

An operational amplifier 241 has an inverting terminal which is connected to the reference voltage terminal VEL and a non-inverting terminal which is connected to a drain of the PMOS 244 and connected to both of a drain of the NMOS 245 and the reference current terminal REL. An output. terminal of the operational amplifier 241 is connected to a gate of the NMOS245. A source of the NMOS 245 is connected to the ground terminal GND. The NMOS 242 has a gate which is connected to the correction voltage terminal OFFSET, a source of which is connected to the ground terminal GND. A first node of a drain of the NMOS242 is connected to both a drain and a gate of the PMOS 243. The PMOS 243 has a source which is connected to the power source terminal VDD, and has the drain and gate which are connected to a gate of the PMOS 244. A source of the PMOS 244 is connected to the power source terminal VDD, the drain of the PMOS 244 is connected to both of the reference current terminal REL and the drain of the NMOS 245. The reference current terminal REL is connected to a power source terminal VDD through the current setting resister 246.

The operational amplifier 241, the NMOS 245 and the current setting resister 246 constitute a feedback circuit. The PMOS 243 and PMOS 244 constitute a current mirror circuit. The reference current terminal REL is connected to driver steps (e.g., the driver cells 250).

The reference voltage generation circuit 240 has the NMOS 242, the NMOS 245, the PMOS 243, and the PMOS 244. In a similar manner, each of the driver cells 250 has an NMOS 251, an NMOS 254, a PMOS 252 and a PMOS 253. A gate of the NMOS 251 is connected to the correction voltage terminal OFFSET, and a source of the NMOS251 is connected to the ground terminal GND. A drain of the NMOS 251 is connected to both of a gate of the PMOS 252 and a gate of the PMOS 253 and also connected to a drain of the PMOS 252. The PMOS 252 and the PMOS 253 constitute a current mirror circuit. A source of the PMOS 252 and a source of the PMOS 253 are connected to the power source terminal VDD respectively. A drain of the PMOS 253 is connected to both of the output terminal OUT and a drain of the NMOS 254. A gate of the NMOS 254 is connected to the output terminal of the operational amplifier 241, and a source of the NMOS254 is connected to the ground terminal GND. The output terminals OUT are connected to the column lines 12 illustrated in FIG. 8, respectively.

The NMOS 242, the NMOS 245 and the PMOS 244 have characteristics similar to those shown in FIG. 9 of the first embodiment. When a power source voltage is supplied to the power source terminal VDD, a reference voltage Vvel is supplied to the reference voltage terminal VEL. When the correction voltage Voffset is supplied to the correction voltage terminal OFFSET, the correction voltage Voffset is applied to the gate of the NMOS 242 so that a first correction current flows through across the drain and source of the NMOS 242. A second correction current Ioffset which is proportional to the first correction current flows through the reference current terminal REL and a current mirror circuit that includes the PMOS 243 and the PMOS 244. When the reference voltage Vvel which appears at the reference voltage terminal VEL is supplied to the inverting terminal of the operational amplifier 241, the feedback circuit that includes the operational amplifier 241, the NMOS 245 and the current setting resister 246 adjusts the gate voltage (=a display voltage Vdata represented by a display data, which is a reference voltage) of the NMOS 245 in order to produce the display current Idata which suffices the bellow equation:
(a magnitude of a voltage of the reference current terminal REL)=(a magnitude of the reference current Iref that flows through the current setting resister 246) multiplied by (a resister value Rref of the current setting resister 246).
The current Iref flowing through the current setting resister 246 is dependent on the correction current Ioffset and the display current Idata, and the reference current Iref is represented by:
Iref=Idata−Ioffset.

When the display voltage Vdata is applied to the gate of the PMOS 254 and the correction voltage Voffset is applied to the gate of the NMOS 251, the column lines 12 are driven by way of the output terminals OUT respectively. Then, the output current Iout flows through current paths including: the power source terminal VDD of the row line selection circuit 20; ‘on’ status of respective switching elements 21; the respective row lines 11; the respective organic electroluminescence elements 13; and the respective column lines 12 and the respective output terminals OUT.

As a result, the respective organic electroluminescence elements 13 light at gradation (luminance) represented by the display data.

Since the driver circuit of the second embodiment includes a current push-pull configuration causing the display current Idata to be drawn by the NMOS 245 and the correction current Ioffset to be injected by the PMOS 244 at the reference current terminal REL in a similar manner of the first embodiment, the display voltage Vdata is shifted (moved) to a magnitude of a desired value by setting the correction voltage Voffset. The display voltage Vdata supplied from the operational amplifier 241 is shifted within a range of operational output voltage by shifting a magnitude of the display voltage Vdata. As a result, a leak current of the NMOS 245, which causes a display voltage error around 0, is corrected.

### Third Embodiment

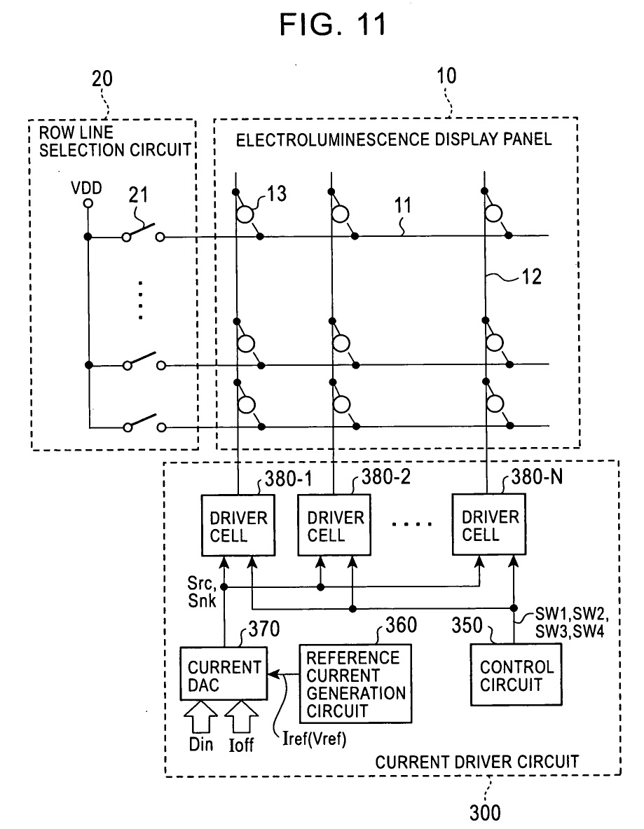

FIG. 11 illustrates a schematic circuit configuration of a current-driven type image displayer (e.g. an organic electroluminescence image displayer) that includes an current driver circuit according to a third embodiment of the present invention.

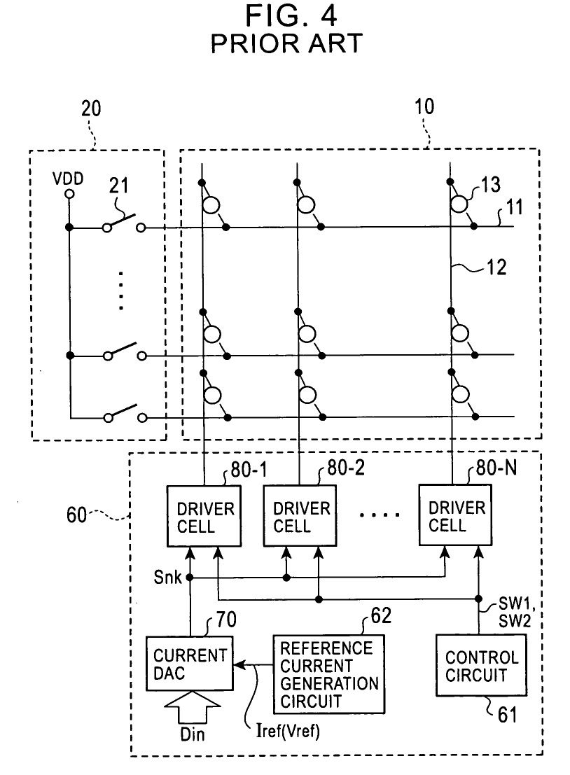

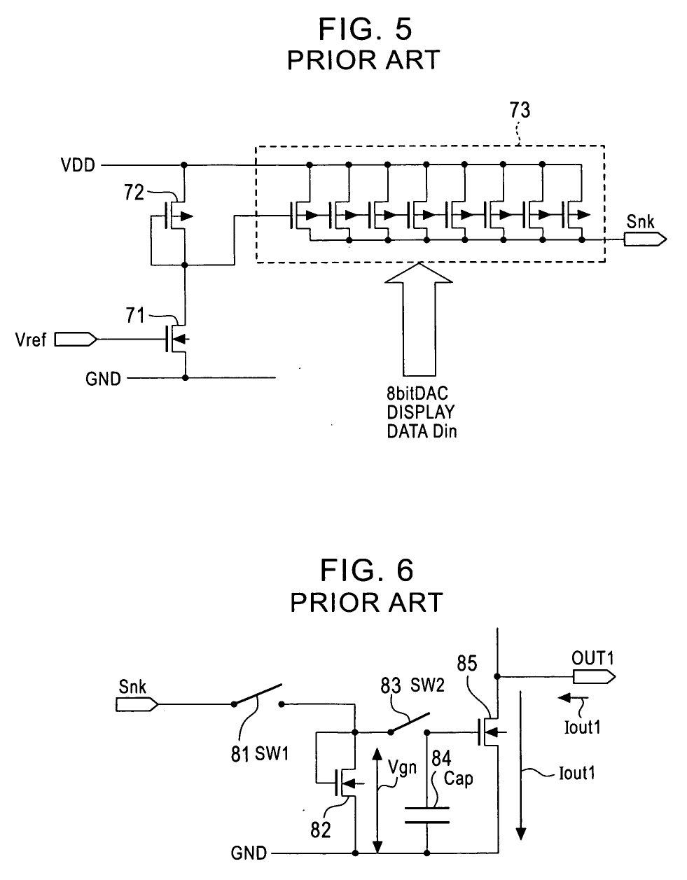

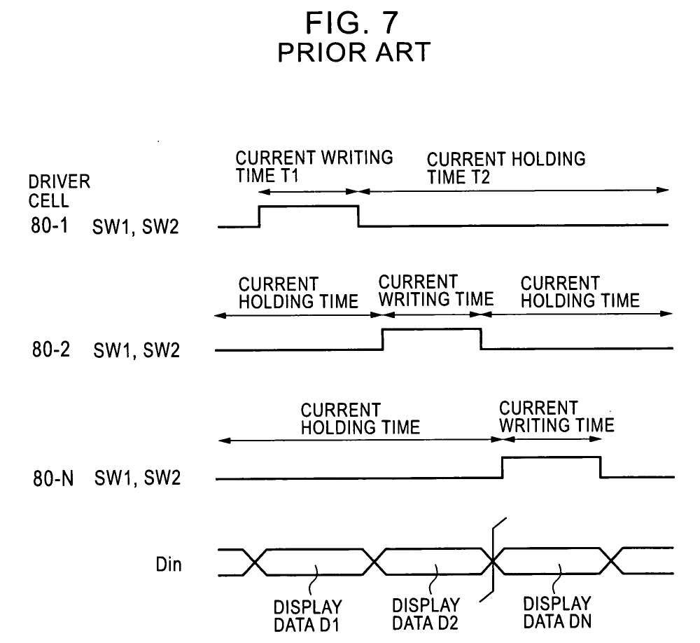

The organic electroluminescence image displayer drives an electroluminescence display panel 10 illustrated in FIG. 4. The organic electroluminescence image displayer includes the electroluminescence display panel 10 and a row selection circuit 20 which are the same as those illustrated in FIG. 4, and further includes a current driver circuit 300 which is different from FIG. 4. The current driver circuit 300 has a control circuit 350 that generates control signals sw1, sw2, sw3, sw4, . . . , in predetermined timing, a reference current generation circuit 360 that supplies a reference voltage Vref with generating a reference current Iref. The current driver circuit 300 further includes a current DAC 370 and a plurality of driver cells 380-1, . . . , 380-N. The current DAC 370 converts a digital display data Din representing a display current into an analog input signal (e.g., a display signal current Snk), and also converts a digital correction data Ioff representing offset current into an analog correction signal (e.g., a correction current Src). The driver cells 380-1, . . . , 380-N drive a plurality of column lines 12 respectively.

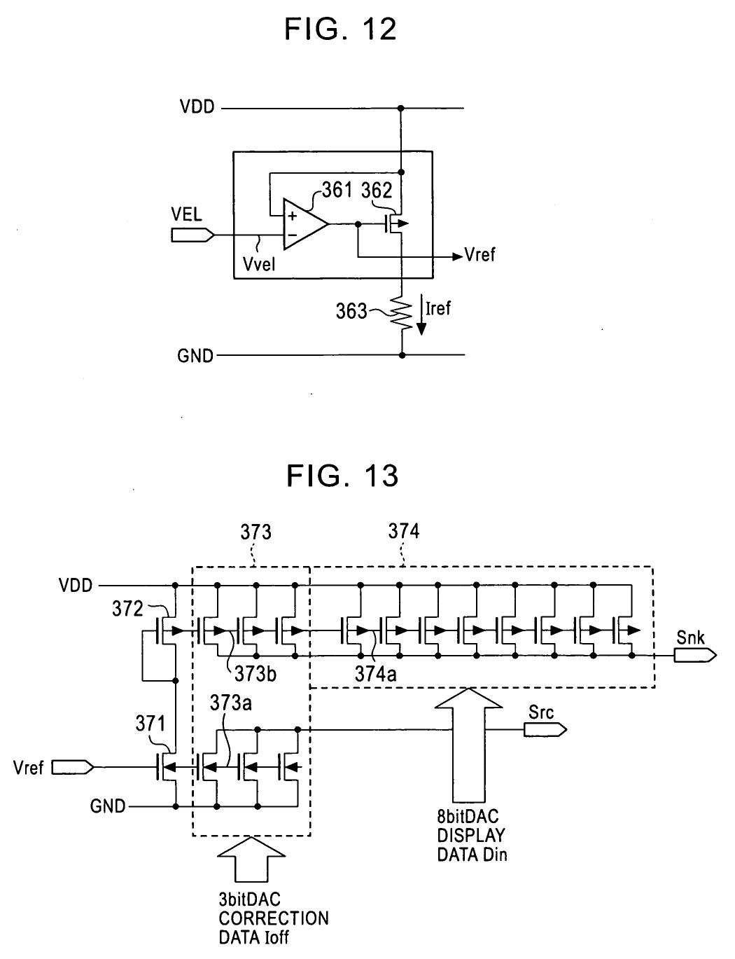

FIG. 12 illustrates a schematic circuit configuration of a reference current driver circuit 360 of FIG. 11. The reference current generation circuit 360 includes an operational amplifier 361 that receives a reference voltage Vvel from a reference voltage terminal VEL, and a PMOS 362 and a load resister 363 which are connected in series to each other between a second power voltage potential node (e.g., a power source terminal VDD) and a first power voltage potential node (e.g., a ground terminal GND). A gate of the PMOS 362 is controlled by the operational amplifier 361. A non-inverting terminal of the operational amplifier 361 is connected to the power source terminal VDD and a source of the PMOS 362 respectively, and an inverting terminal of the operational amplifier 361 is connected to the reference voltage terminal VEL. The output terminal of the operational amplifier 361 produces the reference voltage Vref, which is connected to the gate of the PMOS 362.

By a voltage follower operation of the operational amplifier 361, the gate of the PMOS 362 is controlled to make a voltage of the power source terminal VDD and the reference voltage Vref to become the same as each other. The reference current Iref flows through source and drain of the PMOS 362 and the load resister 363. Then, the reference voltage Vref according to the reference current Iref which is drawn from the output terminal of the operational amplifier 361 is supplied to the current DAC 370.

FIG. 13 illustrates a schematic circuit configuration of a current DAC 370 of in FIG. 11. For example, based on the reference voltage Vref which is supplied from the reference current generation circuit 360, the current DAC 370 supplies the display signal current Snk (=Iref*Din) proportional to the display data Din of eight bits and the correction current Src (=Iref*Ioff) proportional to a correction data of three bits. The current DAC 370 an NMOS 371 which receives the reference voltage Vref, a PMOS 372 functioning as a load resister, and current conversion parts 373 and 374. The NMOS 371 and the PMOS 372 are connected in series to each other between the ground terminal GND and the power source terminal VDD. The current conversion part 373 has two circuitries. The one circuitry is a current mirror circuit that has the NMOS 371 and three NMOSs 373a, which supplies the correction currents Src. The other is a current mirror circuit that has the PMOS 372 and three PMOSs 373b. The current conversion part 374 is connected to the output of circuit having three PMOSs 373b. The current conversion part 374 has a current mirror circuit that has the PMOS 372 and the PMOSs 374a, which supplies the display current Snk.

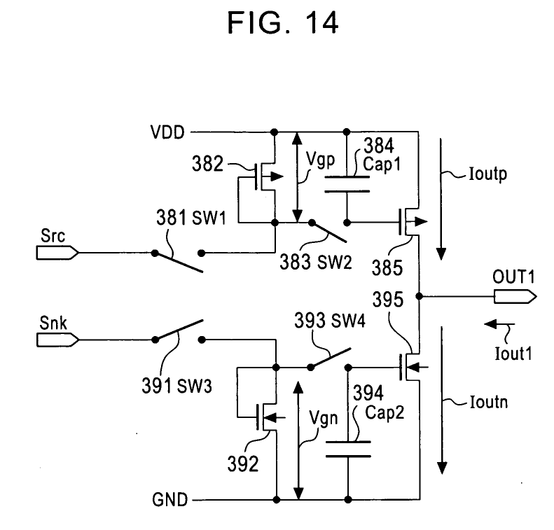

FIG. 14 illustrates a schematic circuit configuration of a driver cell 380-i (i=1, . . . , N) shown in FIG. 11. The driver cell 380-1 has a circuit configuration the same as other driver cells 380-2, . . . , 380-N. The driver cell 380-i latches the correction current Src which is correction current and the display signal current Snk which is an input signal supplied from current DAC 370 respectively and supplies an output current Iout1 via an output terminal OUT1 to drive the column line 12. The driver cell 380-i has the second switches 381 and 383 that draw the correction currents Src which is a correction signal while being controlled by the control signals sw1, sw2 with on/off switching operation. The driver cell further includes a PMOS 382 functioning as a load resister, and a second capacitor 384 that has a magnitude of a capacity value Cap1 functioning as an I/V conversion to control a second control voltage (e.g., a gate voltage Vgp). The driver cell 380-i has a second transistor (e.g., a PMOS 385) that injects an injection current Ioutp which is a correction current in response to a gate terminal voltage Vgp into an output terminal OUT1, and also has first switches 391, 393 that draw the display signal current Snk while being controlled by control signals sw3, sw4 with on/off switching operation. The driver sell 380-i further includes an NMOS 392 functioning as a load resister, a first capacitor 394 that has a magnitude of a capacity value Cap2 functioning as an I/V conversion to control a first control voltage (e.g., a gate voltage Vgn) and a second transistor (e.g., an NMOS 395) that draws a drawing current Ioutn which is an output current in response to a gate terminal voltage Vgn from an output terminal OUT1.

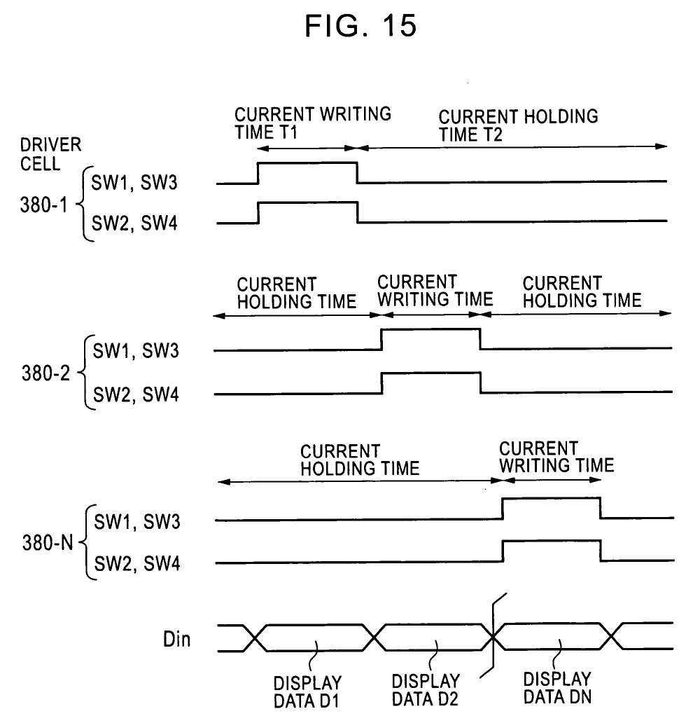

FIG. 15 illustrates timing charts representing signals appearing in circuits of FIG. 11 and FIG. 14. When a power source voltage is applied to the power source terminal VDD and a reference voltage Vvel is applied to the reference voltage terminal VEL of reference current generation circuit 360 illustrated in FIG. 12, a reference current Iref flows through the load resister 363 by voltage follower operation of the operational amplifier 361. As a result, the reference voltage Vref is issued from an output terminal of the operational amplifier 361, which is supplied to the current DAC 370 illustrated in FIG. 13.

When, in the current DAC 370, the reference voltage Vref is supplied to a gate of the NMOS 371, a current flows through the PMOS 372, the NMOS 371, as well as the current conversion parts 373 and 374. The PMOS 372, the NMOS 371, current conversion parts 373 and 374 configure a current mirror circuit. Then, the correction current Src (=−Ioff*Iref) proportional to the correction data Ioff of three bits is issued from three NMOSs 373a of the current conversion part 373. Moreover, the display signal current Snk (=Iref (Ioff+Din)) proportional to the correction data Ioff of three bits and the display data Din of eight bits is issued from the PMOSs 374 of the current conversion part 374. The correction current Src (=−Ioff*Iref) and the display signal current Snk (=Iref (Ioff+Din)) are supplied to the driver cells 380-1, . . . , 380-N respectively.

In the driver cell 380-i illustrated in FIG. 14, the switches 381, 383, 391, 393 become ON during a current writing time T1, and the display signal current Snk proportional to data D1 within a display data (D1, D2, . . . , DN) flows through the NMOS 392 and the capacitor 394. The gate voltage Vgn proportional to the display signal current Snk is generated while the correction current Src flowing through the PMOS 382 and the capacitor 384, and the gate voltage Vgp proportional to the correction current Src is generated. During a next holding time T2, the switches 381, 383, 391, 393 become OFF, the injection currents Ioutp flow through across a source and a drain of the PMOS 385 by the gate voltage Vgp held in the capacitor 384. With this gate voltage Vgn held in the capacitor 394, a drawn current Ioutn flows through across a drain and a source of the NMOS 395, and the output current Iout1 (=Ioutn−Ioutp) is generated at the output terminal OUT1. The output current Iout1 proportional to a data D1 is represented by:
Iout1=Iref*(Ioff−Ioff−D1).

When the output current such as Iout1 flows through the output terminal OUT1, the column line 12 is driven and one of the organic electroluminescence elements 13 lights.

In other driver cells 380-2, . . . , 380-N, writing and holding operations are performed in accordance with the display signal currents Snk respectively proportional to the display data D2, . . . , DN and the correction currents Src respectively. Other organic electroluminescence elements 13 consecutively light by the output current Iout2, . . . , Ioutn respectively flowing through the output terminals OUT2, . . . , OUTN.

The third embodiment is so configured as to draw Ioutn in accordance with the display signal current Snk and to inject the Ioutp in accordance with the correction current Src, at the respective output terminals OUT1, . . . , OUTN of the respective driver cells 380-1, . . . , 380-N, so as to adjest the output current Iout1, . . . , Ioutn. Thus, a writing time T1 can be shortened and operational speed of the current driver circuit 300 can be improved by the correction currents Src (=−Ioff*Iref). As a result, a current error will not increase even when a current writing speed becomes faster.

The present invention is not limited to the above embodiments. For example, the current driver circuit 130, 230, 300 of the embodiments may be changes by using other type of transistors or circuit configurations which are not illustrated.

This application is based on Japanese Patent Application No. 2005-250540 filed on Aug. 31, 2005, and the entire disclosure thereof is incorporated herein by reference.

What is claimed is:

1. A current driver circuit having a current output terminal for supplying a drive current with a magnitude according to a data signal supplied thereto to a data electrode terminal of a current-driven type image displayer, said current driver circuit comprising:
an active current conductive element having a current supply terminal receiving a drive voltage and being connected to said current supply terminal and having an impedance viewed from said current supply terminal and variable in response to a gate control based on said data signal; and
a modification circuit for modifying the impedance of said active current conductive element in response to an external off-set control input signal supplied thereto.

2. A current driver circuit according to claim 1, wherein said active current conductive element is an FET.

3. A current driver circuit according to claim 1, wherein said modification circuit includes a current mirror circuit having a first current passage connected to said current supply terminal of the active current conductive element and a second current passage causing a current of the same magnitude as a current passing through said first current passage to pass therethrough; and an off-set current control element inserted into said second current passage and having an impedance variable with said off-set control input signal.

4. A current driver circuit according to claim 1, further comprising: an adjust circuit for adjusting a magnitude of said data signal in response to said off-set control input signal.

5. A current driver circuit according to claim 1, wherein said modification circuit includes a first D-A converter to convert an analog signal to said data signal, an analog signal holding circuit which holds said analog signal to input said analog signal to a variable impedance element as a control input signal, a second D-A converter to convert an off-set control input signal to an analog control signal, and a current source circuit supplying a gate control current in response to said analog control signal to said active current conductive element.
